(19) United States
(12) Patent Application Publication
(10) Pub. No.: US 2007/0024687 A1
(43) Pub. Date: Feb. 1, 2007

(54) Image drum and image system having the same of solid inkjet image forming apparatus

(75) Inventors: Jeong-yeon Park, Ansan-si (KR); Hyeong-Ill Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/487,354

(22) Filed: Jul. 17, 2006

(30) Foreign Application Priority Data
Jul. 28, 2005 (KR) 2005-69065

(51) Int. Cl. B41J 2/01

(52) U.S. Cl. 347/103

(57) ABSTRACT

An image drum presses and transfers an ink image formed on the surface thereof onto an image receiving medium, and an image system having the same of a solid inkjet image forming apparatus. The image drum includes a first cylindrical body which forms an image on the surface thereof and transfers the image onto an image receiving medium by pressure; a heat generator formed in the first cylindrical body which heats the first cylindrical body; a space part formed between the first cylindrical body and the heat generator; and including a certain amount of operational fluid transferring heat between the first cylindrical body and the heat generator. The operational fluid is contained between the first cylindrical body and the heat generator. Accordingly, when the image drum is heated, the surface temperature of the image drum can be precisely and uniformly controlled, power consumption decreases, and heat is efficiently transmitted.

### CROSS-REFERENCE TO RELATED APPLICATIONS

This application claims the benefit of Korean Application No. 2005-69065, filed Jul. 28, 2005, in the Korean Intellectual Property Office, the disclosure of which is incorporated herein by reference.

### BACKGROUND OF THE INVENTION

1. Field of the Invention

Aspects of the present invention relate to a solid inkjet image forming apparatus which may be applied to a printer, a multi-functional device, a copying machine, and other devices. More particularly, the present invention relates to an image drum which transfers an ink image, formed onto the surface thereof by a solid inkjet head, onto an image receiving medium such as paper and an image system of a solid inkjet image forming apparatus having the same.

2. Description of the Related Art

In general, a solid inkjet image forming apparatus forms an ink image by applying solid ink fused through a solid inkjet head onto the surface of an image drum and forms the desired final image by pressing and transferring the ink image formed on the surface of the image drum onto an image receiving medium, such as paper, overheads, transparencies, etc. The quality of the final image formed on the image receiving medium depends on the surface temperature of the image drum, as well as the uniformity of the surface temperature of the image drum, upon pressing and transferring the ink image formed on the surface of the image drum onto the image receiving medium. Accordingly, to control the quality of the final image, the temperature and uniformity of the surface temperature of the image drum must also be controlled.

FIG. 1 is schematic view showing an image system 10 of a general solid inkjet image forming apparatus.

As shown in FIG. 1, the image system 10 includes an image drum 11, a pressing roller 25 and a medium preheater 23.

The image drum 11 is formed with a cylindrical body 12 having a coating layer 13 on the outer surface of the cylindrical body 12. A cylindrical heater 14 is formed inside of the image drum 11. As shown in FIG. 2, the cylindrical heater 14 has a nicrome wire 16 coiled around a mica vein 15 at certain intervals. The nicrome wire 16 generates heat inside the cylindrical body 12 of the image drum 11 and the air inside the cylindrical body 12 is heated by radiant heat from the nicrome wire 16. The mica vein 15 is supported by a mica fixing panel 17, and the mica fixing panel 17 is fixed on flanges 19 located at opposite ends of a center shaft 18.

A fan 22 is formed on one side of the image drum 11 to cool the image drum 11 to maintain the surface temperature of the image drum 11 at the printing temperature in printing mode. The fan 22 is fixed on a wheel shaft 21 which is externally extended in the axial direction from a wheel 20 formed on the one side of the image drum 11.

A thermistor 29 is formed on one side of the surface of the image drum 11 to detect the surface temperature of the image drum 11 with an electric signal.

The thermistor 29 detects the surface temperature of the image drum 11 and transfers a detected signal to a controller 31. The controller 31 controls the power supplied to the nicrome wire 16 according to the detected signal to maintain the surface temperature of the image drum 11 within a certain range.

The pressing roller 25 is positioned to contact the image drum 11 with a certain pressure to press the image receiving medium P onto the image drum 11.

The medium preheater 23 is formed at an upper part of the image drum 11 in the medium transfer direction to preheat the image receiving medium P before the image receiving medium P, which is transferred by a feeder (not shown), reaches the image drum 11. The medium preheater 23 is formed with a plate heater 24, and has a heat generator 24a built-in.

However, in the conventional image system 10 having the structure described above, the rate of transmitting heat is low because the image drum 11 is at a certain distance from the nicrome wire 16 of the cylindrical heater 14, and the thickness of the image drum 11 blocks some heat transmission with its own thickness. As the temperature partly decreases in the length direction and the circumference direction of the image drum 11, the compensation of temperature deviation is slow. Accordingly, when the surface temperature of the image drum 11 reaches the desired target temperature, such as, for example, the printing temperature, and the cylindrical heater 14 is turned to an ‘off’ state, then overshooting occurs, which indicates that the surface of the image drum 11 is overheated by the latent heat of the cylindrical heater 14, and thereby the surface temperature of the image drum 11 can not be precisely controlled, while the temperature distribution of the image drum 11 can not be uniformly controlled.

In printing mode, as the image drum 11 is cooled using the fan 22 in order to keep the surface temperature of the image drum 11 at the printing temperature, it is difficult to precisely control the surface temperature of the image drum 11 at the printing temperature.

If the surface temperature of the image drum 11 is not controlled precisely or temperature distribution of the image drum 11 is not controlled uniformly, the quality of the image formed on the image receiving medium P may turn out to be poor.

In addition, as the conventional image system 10 uses the cylindrical heater 14, which heats the image drum 11 by radiant heat from the nicrome wire 16, as a heat source, the rate of transmitting heat is low so that it takes a long time for the image drum 11 to reach the target temperature after the power is supplied to the cylindrical heater 14. Accordingly, this low rate of heat transmission through the air causes unnecessary power consumption, which is a major problem with solid inkjet image forming apparatuses.

This unnecessary power consumption especially occurs when the cylindrical heater 14 gets turned ‘off’ and then gets turned ‘on’ again for printing, because the cylindrical heater takes several minutes to warm up.

Additionally, since the conventional image system 10 has a complicated structure, where the cylindrical heater 14 has a mica vein 15 supporting the nicrome wire 16, and the mica fixing panel 17 fixing the mica vein 15 in place, it is difficult to construct the image system and the construction cost is high due to the expensive mica vein 15.

### SUMMARY OF THE INVENTION

Aspects of the present invention are to solve the above and/or other problems and/or disadvantages and to provide at least the advantages described below. Accordingly, an aspect of the present invention is to provide an image drum which precisely and uniformly controls the surface temperature thereof, consumes low power and efficiently transmits heat, and an image system having the same of a solid inkjet image forming apparatus.

Another aspect of the present invention is to provide an image drum with a simple construction to save the fabrication cost and an image system having the same of a solid inkjet image forming apparatus.

In order to achieve the above-described and/or other aspects of the present invention, there is provided an image drum of a solid inkjet image forming apparatus, including a first cylindrical body forming an image on the surface thereof and transferring the image onto the image receiving medium by pressure, a heat generator formed in the first cylindrical body and heating the first cylindrical body, and a space part formed between the first cylindrical body and the heat generator, and a certain amount of operational fluid which transfers heat between the first cylindrical body and the heat generator.

The heat generator may include a second cylindrical body which includes a heating electrode generating resistance heat upon supplying power. Selectively, the heat generator may include a third cylindrical body formed with metal, and a halogen lamp formed in the third cylindrical body.

The first cylindrical body and/or the third cylindrical body may be formed with a metal made up of aluminum, stainless steel, copper or oxide-free copper.

The operational fluid may include methanol or distilled water including methanol. The operational fluid may have a boiling point 0˜1° C. higher than the target temperature required to heat the first cylindrical body, and have non-electric conductivity so it does not transmit the electric current supplied to the heat generator to the first cylindrical body.

Selectively, the space part may further include an inert gas including a halogen material as a catalyst to expedite heat transmission. The inert gas may be argon, and the halogen material may be one of Cl₂, Br₂, CH₂, CH₂Br, CH₂Br₂ and CH₂Cl₂.

Further, the space part further includes a catalyst inserting tube to insert the heat transmission catalyst. The catalyst inserting tube may be made of a material which can withstand high heat and be sealed with high heat after inserting the catalyst. Selectively, the catalyst inserting tube may be made of metal and may be sealed with a separate sealing cover.

An image system of a solid inkjet image forming apparatus according to another embodiment of the present invention includes an image drum including a first cylindrical body forming an image on the surface thereof and transferring the image onto the image receiving medium by pressure, a heat generator formed in the first cylindrical body and heating the first cylindrical body, and a space part formed between the first cylindrical body and the heat generator and including a certain amount of operational fluid transferring heat between the first cylindrical body and the heat generator, and a pressing roller placed to contact the image drum at a certain pressure and pressing the image receiving medium on the image drum at a certain pressure.

Further, the space part further includes a catalyst inserting tube to insert the heat transmission catalyst. The catalyst inserting tube may be made of a material which can withstand high heat and be sealed with high heat after inserting the catalyst. Selectively, the catalyst inserting tube may be made of metal and be sealed with a separate sealing cover.

The image drum may be controlled to idle at certain rates in the warm-up mode, the standby mode and the sleep mode.

The image system may further include a medium preheater preheating the image receiving medium before the image receiving medium reaches a nip between the image drum and the pressing roller. The medium preheater may include a plate heater where the heat generator is built-in.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partially-cut perspective view illustrating an image system of a general solid inkjet image forming apparatus;

FIG. 2 is a schematic perspective view illustrating the cylindrical heater of the image drum of the image system shown in FIG. 1;

FIG. 3 is a partially-cut perspective view illustrating an image system of a solid inkjet image forming apparatus according to an embodiment of the present invention;

FIG. 4 is a front sectional view illustrating the image drum of the image system shown in FIG. 3;

FIGS. 5A and 5B are partial sectional views illustrating the image drum cut along the line I-I and the line II-II in FIG. 4, respectively; and

FIGS. 6A and 6B are partial sectional views illustrating an altered example of the image drum cut along the line I-I and the line II-II in FIG. 4, respectively.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

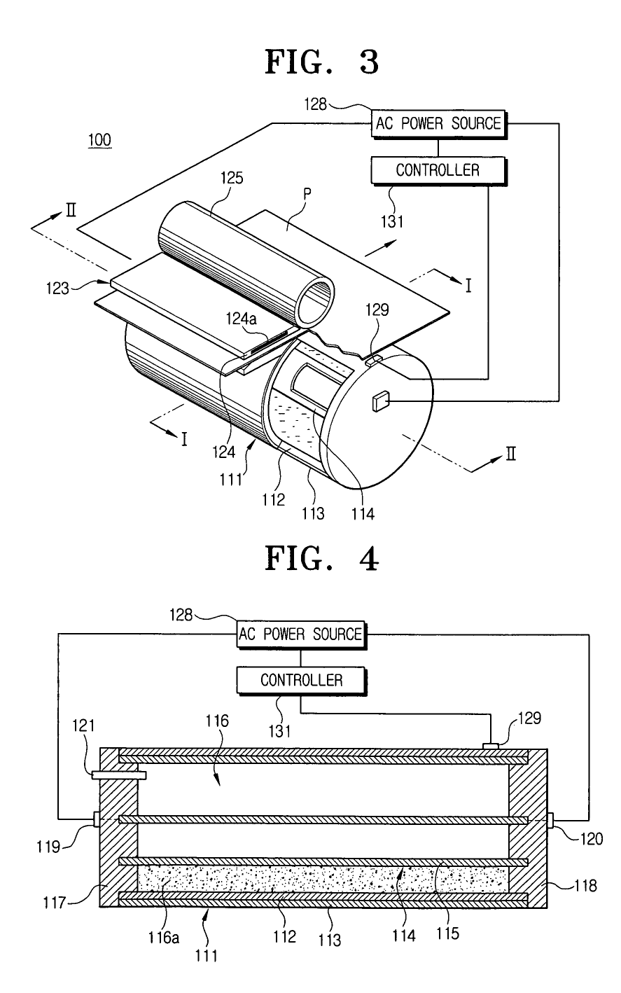

FIG. 3 schematically shows an image system 100 of a solid inkjet image forming apparatus having an image drum 111 according to an embodiment of the present invention.

As shown in FIG. 3, the image system 100 includes an image drum 111, a pressing roller 125 and a medium preheater 123.

As shown in FIG. 4, the image drum 111 includes a first cylindrical body 112 which is hollow and has a coating layer 113 on the outer surface of the first cylindrical body 112.

The first cylindrical body 112 is formed with a metal having a high thermal conductivity, such as aluminum, stainless steel, copper or oxide-free copper. The coating layer 113 is formed with a silicon oil layer. The silicon oil layer makes an ink image, formed by fused ink which is ejected through a solid inkjet head (not shown), and which is separable so that the ink image can be properly transferred onto an image receiving medium, such as paper, overheads, transparencies, etc.

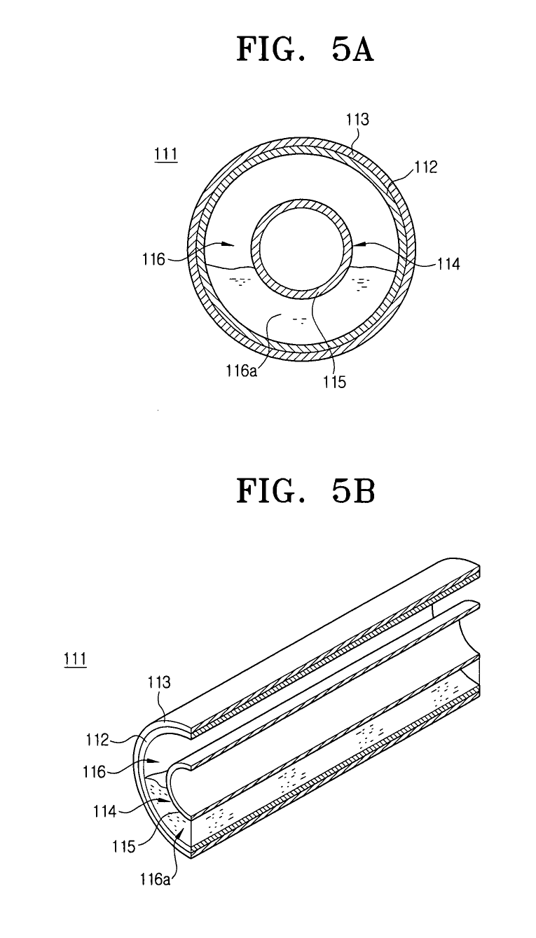

As shown in FIGS. 5A and 5B, a heat generator 114 for generating heat is formed in the first cylindrical body 112.

The heat generator 114 is formed with a second cylindrical body 115 which is hollow and includes a heating electrode generating resistance heat upon supplying an electric current. The heating electrode is formed with metal such as a nickel-chrome alloy. On opposite ends of the second cylindrical body 115 are first and second electrode pads 119 and 120, which are connected to an alternating current (AC) power source 128 through lead lines. This AC power source is connected to a controller 131.

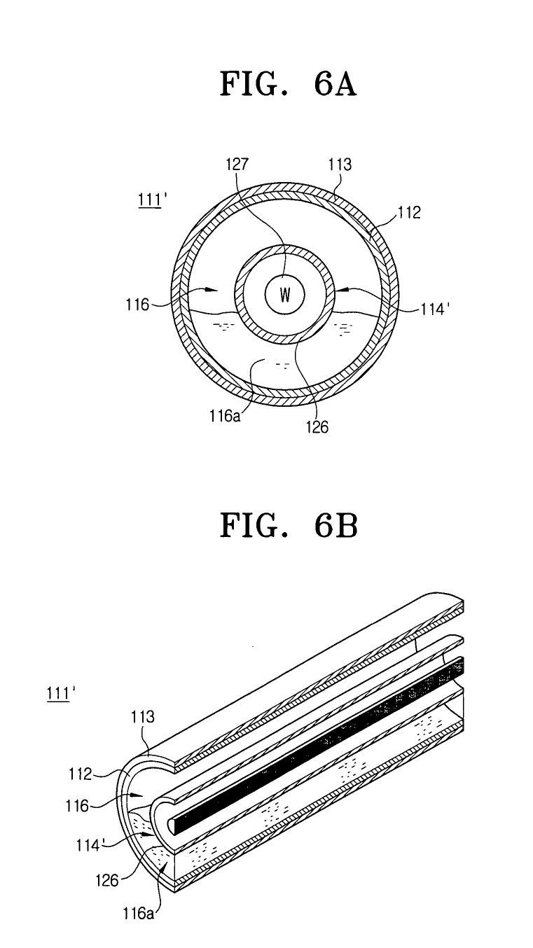

Selectively, as shown in FIGS. 6A and 6B, a heat generator 114′ includes a third cylindrical body 126 which is hollow and formed with metal having a high thermal conductivity, such as aluminum, stainless steel, copper or oxide-free copper, and a halogen lamp 127 which is formed in the third cylindrical body 126.

A space part 116 is ring-shaped and formed between the first cylindrical body 112 and the heat generator 114.

A certain amount of operational fluid 116a is contained in the space part 116 and transfers heat between the first cylindrical body 112 and the heat generator 114.

Both ends of the space part 116 are sealed to be airtight by first and second flanges, 117 and 118, respectively, which are attached to opposite ends of the first cylindrical body 112, and are also attached to opposite ends of the heat generator 114, as shown in FIGS. 3 and 4.

The operational fluid 116a preferably occupies 5˜50% of the volume of the space part 116, and more preferably occupies 5˜15% of the volume of the space part 116. When the heat generator 114 is turned ‘on’, the operational fluid 116a heats the entire first cylindrical body 112, that is, the image drum 111. When the surface temperature of the image drum 111 reaches the target temperature, such as the printing temperature (for example, 62˜67° C.), the heat generator 114 is turned ‘off’, and the operational fluid 116a absorbs the latent heat generated from the heat generator 114 by vaporization, so that overshooting over the top limit of the printing temperature by overheating of the image drum 111 is prevented. When the heat generator 114 is turned ‘off’ and the surface temperature of the image drum 111 decreases, the vaporized operational fluid 116a becomes liquefied and therefore prevents the surface temperature of the image drum 111 from dropping sharply.

The operational fluid 116a may be methanol or distilled water including methanol. Methanol has a boiling point 0˜1° C. higher than the target temperature, that is, the printing temperature to heat the first cylindrical body 112 of the image drum 111, and has non-electric conductivity so it does not transmit the electric current supplied to the second cylindrical body 115 of the heat generator 114 to the first cylindrical body 112.

The operational fluid 116a may also be other fluids which have boiling points 0˜1° C. higher than the printing temperature and have non-electric conductivity. The operational fluid is not limited to being methanol or distilled water including methanol.

Therefore, even though the operational fluid 116a repeats vaporization and condensation in the space part 116 by the heat generator 114, the boiling point of the operational fluid 116a is equal or higher than the printing temperature, preventing explosion or transformation of the first cylindrical body 112 of the image drum 111.

Alternatively, the space part 116 can further include an inert gas including a halogen material as a catalyst to expedite heat transmission. The inert gas may be argon and the halogen material may be one of Cl₂, Br₂, CH₂, CH₂Br, CH₂Br₂ and CH₂Cl₂.

In an embodiment including an inert gas as a catalyst to expedite heat transmission, a catalyst inserting tube 121 is formed on the first flange 117 to insert the heat transmission catalyst, as shown in FIG. 4. The catalyst inserting tube 121 is preferably made of a material which can withstand high heat and be sealed with high heat after it is inserted into the first flange 117.

While the catalyst inserting tube 121 may be formed on the first flange 117, it is not limited to being formed on the first flange 117. The catalyst inserting tube 121 may also be formed in various other places of the image drum 111, including, but not limited to, the second flange 118.

The catalyst inserting tube 121 can be made of metal and be sealed with a separate sealing cover (not shown).

The image drum 111 is controlled to idle at a regular rate by a driving part (not shown), which is controlled by the controller 131 (FIGS. 3 and 4), in order to uniformly transmit heat from the heat generator 114 to a part of the first cylindrical body 112, since the operational fluid 116a only contacts part of the first cylindrical body 112 at any given moment.

The image drum 111 may be heated to different temperatures depending on the desired function. During printing, the printing temperature should preferably be heated to 62˜67° C. When the image drum 111 is in standby mode, the standby temperature should be equal to the printing temperature or a few degrees lower. In sleep mode, the temperature should be maintained at a lower temperature than the standby temperature.

Accordingly, since the image drum 111 contains operational fluid 116a to expedite heat transmission in the space part 116 between the first cylindrical body 112 and the heat generator 114, heat can be rapidly transmitted from the heat generator 114 to the first cylindrical body 112 of the image drum 111 without a drop in efficiency of heat transmission.

A thermistor 129 is formed on one side of the external surface of the image drum 111 to detect the surface temperature of the image drum 111 using an electric signal.

The thermistor 129 detects the surface temperature of the image drum 111 and transfers a detected signal to the controller 131. The controller 131 controls the power supplied to the heat generator 114 through the AC power source 128 according to the detected signal in order to maintain the surface temperature of the image drum 111 within a certain range.

The pressing roller 125 is positioned to contact the image drum 111 and supply a certain pressure to press an image receiving medium P onto the image drum 111.

The medium preheater 123 is positioned above the image drum 111 in the medium transfer direction to preheat the image receiving medium P before the image receiving medium P, which is transferred by a feeder (not shown), passes through the image drum 111. The medium preheater 123 is formed with a plate heater 124 which has a heat generator 124a, such as nicrome wire, built-in. The plate heater 124 is connected to the AC power source 128.

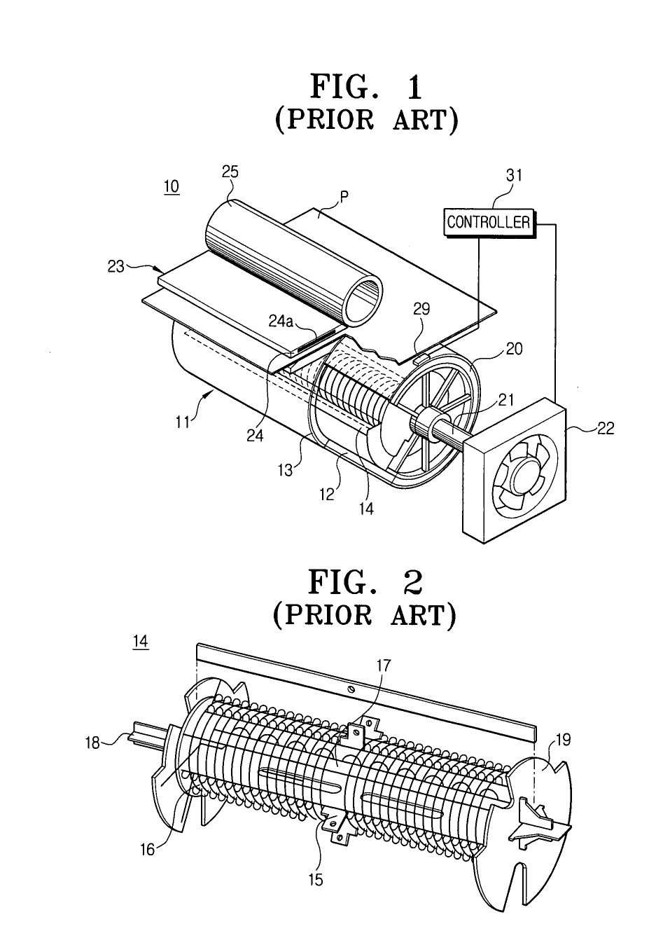

As described above, in the image system 100 according to aspects of the present invention, the operational fluid 116a is contained between the first cylindrical body 112 and the heat generator 114 in the image drum 111. When the image drum 111 is heated, the image drum 111 rotates. Accordingly, the surface temperature of the image drum 111 can be uniformly controlled in the length direction and the circumference direction, especially, in the length direction of the image drum 111, compared with a conventional image system 10 (as shown in FIG. 1) where a cylindrical heater 14 is positioned at a certain distance from the cylindrical body 12 and heats the image drum 11 by radiant heat. The surface temperature deviation of the improved image drum 111 in the length direction has been measured to be equal to ±1° C. or less.

Further, in the image system 100 according to aspects of the present invention, heat is transmitted by the operational fluid 116a. Accordingly, when the surface temperature of the image drum 111 reaches the target temperature, i.e., the printing temperature, and the heat generator 114 is turned ‘off’, the operational fluid 116a absorbs the latent heat generated from the heat generator 114 by vaporization, effectively preventing overshooting over the top limit of the printing temperature by overheating of the image drum 111 As a result, the surface temperature of the image drum 111 can be precisely controlled.

Further, in the image system 100 according to aspects of the present invention, as the operational fluid 116a transmits heat, the rate of heat transmission is high and heat loss is low, compared with the conventional image system 10 which transmits heat through air. Accordingly, the image system 100 according to aspects of the present invention can reach a target temperature, such as a desired printing temperature, using a lower amount of electric power within a faster time period than the conventional image system 10. As a result, consumption power, which is a major issue for solid inkjet image forming apparatuses, is decreased.

Further, in the image system 100 according to aspects of the present invention, the operational fluid 116a is contained between the first cylindrical body 112 and the heat generator 114 so that construction of the embodiments of the present invention becomes much simpler compared to construction of the conventional image system 10 (as shown in FIG. 1). Accordingly, embodiments of the present invention are easy to construct and the construction cost is reduced compared to the conventional image system 10, due to the decrease in components as compared with the conventional image system 10.

The image system 100 having the above construction operates as follows.

First, when a printing command is transmitted to the solid inkjet image forming apparatus, the controller 131 controls the AC power source 128 to supply voltage of AC 220 or 100V to the plate heater 124 and the heat generator 114. Accordingly, the warm-up mode is initiated, so that the plate heater 124 and the surface of the image drum 111 are heated to a certain temperature, for example, the printing temperature of 62˜67° C.

Heat generated from the heat generator 114 is partly radiated to the first cylindrical body 112 through empty space, or the heat transmission catalyst of argon gas including a halogen material, to heat the surface of the image drum 111. Also, heat is partly transmitted to the first cylindrical body 112 through the operational fluid 116a to heat the surface of the image drum 111.

Heat transmitted to the operational fluid 116a is transmitted to the first cylindrical body 112 through the operational fluid 116a which has high thermal conductivity. When trying to reach a target temperature of 62˜67° C., the image drum 111 according to aspects of the present invention reaches the printing temperature within several minutes.

Further, the driving part (not shown), which is controlled by the controller 131, rotates the image drum 111 at a regular rate to uniformly heat the surface by the operational fluid 116a.

Subsequently, when the surface of the image drum 111 reaches the desired printing temperature, the thermistor 129 outputs a detected signal to the controller 131 and the controller 131 controls the AC power source 128 to switch off the heat generator 114.

In that case, the operational fluid 116a absorbs the latent heat generated from the heat generator 114 by vaporization and therefore prevents overshooting over the top limit of the printing temperature by overheating of the first cylindrical body 112, that is, the image drum 111.

Next, an ink image is formed on the surface of the image drum 111 by the solid inkjet head (not shown) which jets fused solid ink according to an image signal input from a computer.

Meanwhile, the image receiving medium P is picked up and transmitted to the plate heater 124 by the feeder and is then preheated by the plate heater 124.

Therefore, when the image receiving medium P passes through the image drum 111, the surface temperature of the image drum 111 does not sharply decrease.

After passing over the plate heater 124, the image receiving medium P is transmitted to a nip between the image drum 111 and the pressing roller 125, and the pressing roller 125 presses the image receiving medium P on the image drum 111 with a certain pressure in the nip. Accordingly, the ink image formed on the surface of the image drum 111 is transferred onto the image receiving medium P.

In the transferring process, if heat of the image drum 111 is transferred to the image receiving medium P, the operational fluid 116a in the space part 116 is liquefied and the heat generator 114 heats the liquefied operational fluid 116a to vaporize again.

If the surface temperature of the image drum 111 is lower or higher than the printing temperature in the above process, the thermistor 129 detects the surface temperature of the image drum 111 and outputs the detected signal to a controller 131. The controller 131 controls the AC power source 128 to switch the heat generator 114 ‘on’ and ‘off’ and keeps the surface temperature of the image drum 111 within a range of the desired printing temperature.

The image receiving medium P, where the ink image is transferred to by pressure, is transmitted to a discharge part (not shown) and is externally discharged by a discharge roller (not shown) of the discharge part.

If printing is finished, the controller 131 controls the heat generator 114 according to a detected signal from the thermistor 129 to keep the image drum 111 in standby mode, until a printing command is inputted again. That is, the surface temperature of the image drum 111 keeps the standby temperature equal to the printing temperature or a few ° C. lower. If a printing command is not inputted after the image system 100 is in standby mode for a certain amount of time, the controller 131 performs the sleep mode in order for the surface temperature of the image drum 111 to maintain a lower temperature than the standby temperature.

To uniformly maintain a lower temperature, the image drum 111 rotates at a regular rate by a driving part, which is controlled by the controller 131, to uniformly heat the surface by the operational fluid 116a.

As can be appreciated from the above description of the image drum 111 and the image system 100 having the same of the solid inkjet image forming apparatus according to aspects of the present invention, the operational fluid 116a is contained between the first cylindrical body 112 and the heat generator 114 in the image drum 111. When the image drum 111 is heated, the image drum 111 rotates. Accordingly, the surface temperature of the image drum 111 can be uniformly controlled in the length direction and the circumference direction, especially, in the length direction of the image drum 111, compared with a conventional image system where a cylindrical heater is at a certain distance from the cylindrical body so that an image drum is heated by radiant heat. As the result, the quality of the image can improve.

Further, in the image drum 111 and the image system 100 having the same of the solid inkjet image forming apparatus according to aspects of the present invention, heat is transmitted by the operational fluid 116a. Accordingly, when the surface temperature of the image drum 111 reaches the printing temperature and the heat generator is turned ‘off’, the operational fluid 116a absorbs the latent heat generated from the heat generator 114 by vaporization so that overshooting over the top limit of the printing temperature by overheating of the image drum 111 is prevented. As a result, the surface temperature of the image drum 111 can be precisely controlled.

Further, in the image drum 111 and the image system 100 having the same of the solid inkjet image forming apparatus according to aspects of the present invention, as the operational fluid 116a transmits heat, the rate of heat transmission is high and heat loss is low, compared with the conventional image system which transmits heat through air. Accordingly, the image system according to aspects of the present invention can reach the target temperature, such as the printing temperature, using a lower amount of electric power and within a faster amount of time than the conventional image system. As a result, consumption power, which is a major issue for solid inkjet image forming apparatuses, is decreased.

Further, in the image drum 111 and the image system 100 having the same of the solid inkjet image forming apparatus according to aspects of the present invention, the operational fluid 116a is contained between the first cylindrical body 112 and the heat generator 114 so that the construction is simpler and cheaper than the conventional image system which transmits heat through air. Accordingly, it is easy to construct embodiments of the present invention and the construction cost is decreased due to a decrease in components compared with the conventional image system.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image drum of a solid inkjet image forming apparatus, comprising:
a first cylindrical body upon which an image is formed on a surface thereof and which transfers the image onto an image receiving medium;
a heat generator formed in a first cylindrical body which heats the first cylindrical body;
a space part formed between the first cylindrical body and the heat generator; and
operational fluid inside the space part, which transfers heat between the first cylindrical body and the heat generator.

2. The image drum of claim 1, wherein the heat generator comprises:
a heating electrode which generates resistance heat upon supplying power; and
a second cylindrical body housed within the first cylindrical body and attached to the heating electrode.

3. The image drum of claim 2, wherein the first cylindrical body is formed from aluminum, stainless steel, copper or oxide-free copper.

4. The image drum of claim 1, wherein the heat generator comprises
a third cylindrical body formed with metal housed within the first cylindrical body; and
a halogen lamp formed in the third cylindrical body.

5. The image drum of claim 4, wherein the first cylindrical body and the third cylindrical body are formed from aluminum, stainless steel, copper or oxide-free copper.

6. The image drum of claim 1, wherein the operational fluid comprises methanol.

7. The image drum of claim 1, wherein the operational fluid comprises distilled water including methanol.

8. The image drum of claim 1, wherein the operational fluid has a boiling point 0˜1° C. higher than a target temperature required to heat the first cylindrical body.

9. The image drum of claim 8, wherein the operational fluid has a non-electric conductivity.

10. The image drum of claim 1, wherein the space part further comprises an inert gas including a halogen material as a catalyst to expedite heat transmission.

11. The image drum of claim 10, wherein the inert gas comprises argon.

12. The image drum of claim 11, wherein the halogen material is selected from the group consisting of Cl₂, Br₂, CH₂, CH₂Br, CH₂Br₂ and CH₂Cl₂.

13. The image drum of claim 10, wherein the space part further comprises a catalyst inserting tube to insert the heat transmission catalyst.

14. The image drum of claim 13, wherein the catalyst inserting tube comprises a material which can withstand high heat and be sealed with high heat after the catalyst is inserted into the space part.

15. The image drum of claim 13, wherein the catalyst inserting tube comprises metal and is sealed with a separate sealing cover.

16. An image system of a solid inkjet image forming apparatus, comprising:
an image drum, comprising:
a first cylindrical body upon which an image is formed on a surface thereof and which transfers the image onto an image receiving medium;
a heat generator formed in a first cylindrical body which heats the first cylindrical body;
a space part formed between the first cylindrical body and the heat generator; and
operational fluid inside the space part which transfers heat between the first cylindrical body and the heat generator;
and;
a pressing roller which contacts the image drum and presses the image receiving medium against the image drum

17. The image system of claim 16, wherein the heat generator comprises:
a heating electrode which generates resistance heat upon supplying power; and
a second cylindrical body housed within the first cylindrical body and attached to the heating electrode.

18. The image system of claim 17, wherein the first cylindrical body is formed from aluminum, stainless steel, copper or oxide-free copper.

19. The image system of claim 16, wherein the heat generator comprises
a third cylindrical body formed with metal housed within the first cylindrical body; and
a halogen lamp formed in the third cylindrical body.

20. The image system of claim 19, wherein the first cylindrical body and the third cylindrical body are formed from aluminum, stainless steel, copper or oxide-free copper.

21. The image system of claim 16, wherein the operational fluid comprises methanol.

22. The image system of claim 16, wherein the operational fluid comprises distilled water including methanol.

23. The image system of claim 16 wherein the operational fluid has a boiling point 0˜1° C. higher than a target temperature required to heat the first cylindrical body.

24. The image drum of claim 23, wherein the operational fluid has a non-electric conductivity.

25. The image system of claim 16, wherein the space part further comprises an inert gas including a halogen material as a catalyst to expedite heat transmission.

26. The image system of claim 25, wherein the inert gas comprises argon.

27. The image system of claim 26, wherein the halogen material is selected from the group consisting of Cl₂, Br₂, CH₂, CH₂Br, CH₂Br₂ and CH₂Cl₂.

28. The image system of claim 25, wherein the space part further comprises a catalyst inserting tube to insert the heat transmission catalyst.

29. The image system of claim 28, wherein the catalyst inserting tube comprises a material which can withstand high heat and be sealed with high heat after the catalyst is inserted into the space part.

30. The image system of claim 28, wherein the catalyst inserting tube comprises metal and is sealed with a separate sealing cover.

31. The image system of claim 16, further comprising a controller, wherein the controller controls the image drum to idle at certain rates in the warm-up mode, the standby mode and the sleep mode.

32. The image system of claim 16, further comprising a medium preheater which preheats the image receiving medium before the image receiving medium reaches a nip between the image drum and the pressing roller.

33. The image system of claim 32, wherein the medium preheater comprises a plate heater having a built-in heat generator.

34. An image drum of a solid inkjet image forming apparatus, comprising:
a first cylindrical body upon which an image is formed on a surface thereof and which transfers the image onto an image receiving medium;
a heat generator formed in the first cylindrical body;
a space part formed between the first cylindrical body and the heat generator; and
operational fluid inside the space part, wherein the operational fluid vaporizes at a certain temperature to prevent overheating of the first cylindrical body.

35. An image drum of a solid inkjet image forming apparatus, comprising:
a first cylindrical body upon which an image is formed on a surface thereof and which transfers the image onto an image receiving medium;
a heat generator formed in the first cylindrical body;
a space part formed between the first cylindrical body and the heat generator; and
a heating medium inside the space part, wherein the heating medium transfers heat between the first cylindrical body and the heat generator and changes phase to prevent the first cylindrical body from overheating.

36. The image drum of 35, wherein the heating medium comprises distilled water including methanol.

37. The image drum of claim 35, wherein the heating medium has a boiling point 0˜1° C. higher than a target temperature required to heat the first cylindrical body.

38. The image drum of claim 37, wherein the heating medium has a non-electric conductivity.
